(19) United States
(12) Patent Application Publication
(10) Pub. No.: US 2018/0015612 A1
(43) Pub. Date: Jan. 18, 2018

(54) HANDHELD VACUUM AND COLLECTION DEVICE

(71) Applicant: Marc R. Price, Prairie Village, KS (US)

(72) Inventor: Marc R. Price, Prairie Village, KS (US)

(21) Appl. No.: 15/649,638

(22) Filed: Jul. 13, 2017

Related U.S. Application Data
(60) Provisional application No. 62/493,660, filed on Jul. 13, 2016.

(51) Int. Cl. B25J 1/04; B25J 11/00

(52) U.S. Cl. CPC B25J 1/04; B25J 11/0085

(57) ABSTRACT

The present invention relates to a lightweight device that is able to collect relatively lightweight objects of various sizes and shapes through the use of a vacuum combined with a mechanical snare. Devices of the invention can be operated with a single hand. The invention provides improved means of collecting small objects, dust, dirt, or other small debris without requiring excessive bending or stooping by the user.

### BACKGROUND OF THE INVENTION

### A. Field of the Invention

The present invention generally relates to a handheld device for collecting relatively lightweight debris or objects of various sizes by using a vacuum, mechanical snare, or both to collect debris or objects. Specifically, the present invention allows a user to operate both a vacuum and mechanical snare separately or simultaneously.

### B. Description of the Related Art

Individuals having health, mobility, visibility, aging or coordination disabilities often have difficulty reaching, picking up, or grasping objects by hand. Such difficulties can make the most routine daily tasks challenging to accomplish. In such instances, individuals either must rely on the assistance of another individual or on devices to accomplish the desired tasks.

A number of devices have been developed to assist individuals and make it easier for them to accomplish the tasks of daily living without additional assistance. Nevertheless, no single device is able to mimic all of the different types of movements that are required to accomplish a variety of tasks. As a result, an individual may need to use multiple devices to accomplish a single task.

### SUMMARY OF THE INVENTION

The present invention provides a device that is able to function as both a vacuum and a mechanical snare to collect a variety of relatively lightweight objects of various shapes and sizes. Advantageously, the vacuum and mechanical snare can be operated either in tandem or separately from another. This versatility allows a user to use a single device to accomplish a multitude of daily tasks.

The present invention incorporates a design that effectively extends a user's reach so that the need to bend or reach is reduced. Advantageously, by reducing the need to bend or reach a user can accomplish a task with less strength and flexibility. Further, the invention allows a user to effectively conduct a variety of tasks without having to use multiple devices.

Devices of the present invention are able to collect and pick up small objects by using a vacuum, as well as, capture larger, relatively lightweight objects with a mechanical snare. Both the vacuum and the mechanical snare are powered by a motor that is housed in the handles of the devices of the invention.

The invention provides devices comprising both a vacuum and a mechanical snare. A device of the invention includes a handle, an electric motor able to create vacuum suction, a tube with a collection compartment, and a mechanical snare that is attached along a side of the tube and near its distal end having the collection compartment and operably linked to the handle by a pulley, cable, rod, or combination thereof. Preferably, the mechanical snare is powered by the electric motor.

The invention provides handheld devices having a handle; a motor that can generate vacuum pressure and is housed within the handle; a tube attached to the handle and through which the vacuum pressure can pass, wherein the tube includes a closure flap, a capture compartment and a filter guard in the half of the tube distal from the handle; and a mechanical snare comprising two or more movable appendages attached to the side of the tube near the end of the tube distal to the handle, wherein during operation a vacuum is generated such that an object is drawn into the capture compartment and the appendages are movable and able to hold and release an object.

The invention also provides methods of operating handheld devices having a handle; a motor that can generate vacuum pressure and is housed within the handle; a tube attached to the handle and through which the vacuum pressure can pass, wherein the tube includes a closure flap, a capture compartment and a filter guard in the half of the tube distal from the handle; and a mechanical snare comprising two or more movable appendages attached to the side of the tube near the end of the tube distal to the handle, wherein during operation a vacuum is generated such that an object is drawn into the capture compartment and the appendages are movable and able to hold and release an object.

Preferably, the motor is housed in the handle. The tube is attached to the handle, and the tube includes an intake port that is located distally to the handle, a first filter guard, and a collection compartment. The collection compartment is in the half of the tube nearest to the intake port, more preferably the collection compartment is located in the third, and even more preferably the quarter, of the tube nearest to the intake port. The first filter guard is located between the first collection compartment and the handle. The vacuum device is operable with one hand.

In preferred embodiments of the invention, an electric cord supplies power to the motor. Preferably, the electric cord is retractable. Alternatively, one or more batteries may be incorporated with the motor. Those of skill in the art will appreciate that the inclusion of batteries in devices of the invention depends upon the weight of the batteries, as well as, the amount of power that is needed to operate the motor for any specified period of time.

Preferred embodiments of the invention include a second filter guard that is located in the half of the tube most adjacent to the handle.

Devices of the invention include either a telescoping tube or a tube that does not fold or collapse.

Preferably, handles of the vacuum devices include an operating mechanism that is an on/off mechanism, a reverse mechanism, a light switch, or any combination thereof. Handles may include a wrist strap, reflector, light, or any combination thereof.

The invention provides a method of collecting objects using a vacuum and a mechanical snare.

Certain embodiments of the invention operate by using a motor having a battery(ies). In other embodiments the motor may be operated with an electrical cord. Preferred motors have one or more fans. The motor may be located in multiple positions. It is preferred that the motor is located adjacent to, or more preferably within, the handle area. If the motor is battery-operated, then preferably the battery(ies) is located in or adjacent to the handle area. If the motor is operated with an electrical cord, then preferably the cord is retractable and located in or adjacent to the handle area. Those of skill in the art will recognize that a wide variety of motors suitable for use in the invention are available. It is expected that any suitable motor, battery, or cord may be used in the invention.

When the motor is located within the handle area, preferably the handle is vented. Either single or multiple vents may be present in the handle. The number of vents present will, in part, be determined by the size of the vent(s), the amount of air circulation that is required for a motor and/or fan to operate, and the amount of air circulation required to create suction to collect material into the device's compartment. Those of skill in the art will be familiar with the principles governing vacuum technology and how to determine the number and size of the vents.

Advantageously, certain embodiments of the invention that are useful for the vacuum collection of objects are designed so that when the vacuum is not operating, then the collected objects are retained within the device. These embodiments include a tube closure, such as a flap, fold, or other suitable means known in the art, that attaches to the tube and is adjacent to the intake port. When the vacuum device is not in operation, the tube closure covers the intake port. When a vacuum force is applied, or the user operates an opener-closer, then the tube closure is held or forced against the interior of the tube such that objects can be drawn into the capture compartment. When the vacuum force is removed, or the user operates the opener-closer, then the tube closure returns to its resting position and covers the intake port such that collected objects stay in the capture compartment. Alternatively or additionally, a bag can be placed in the capture compartment to hold vacuumed objects. A bag having vacuumed objects either may be removed from the device or left in the compartment and portions of the bag that are exterior to the collection compartment can be tucked into the compartment.

When the user wishes to remove the objects, the user can operate a switch, button, lever, or other release mechanism on, contiguous with, adjacent to, or near the handle to open the device, or preferably the compartment containing the object, and either allow gravity to cause the objects to empty, or drop, from the collection compartment, or alternatively, cause the air flow in the device to reverse and forcibly expel the objects. By locating a release mechanism on, contiguous with, adjacent to, or near the handle area, the user has the opportunity to operate the device with a single hand. Alternatively or additionally, a release mechanism may be located in the distal half of the device closer to the collection compartment.

Embodiments of the invention include a mechanical snare to collect objects with or without operating the vacuum. Preferably, the means is attached to the device near or adjacent to the opening through which objects move into a capture compartment of the device.

Preferred embodiments of the invention are made primarily of plastic or other lightweight materials. Those of skill in the art will be familiar with the wide variety of materials that are suitable for the manufacture of various components of the invention. Those of skill in the art will also appreciate that preferred embodiments of the invention will be relatively lightweight. More specifically, embodiments of the invention are expected to weigh less than 15 lbs., preferred embodiments weigh less than 10 lbs., more preferably less than 9, 8, 7, or 6 lbs., and most preferably less than 5 lbs.

Before describing the present invention in detail, it is to be understood that this invention is not limited to the exemplary embodiments. Other objects, features and advantages of the present invention will become apparent from the following detailed description. It should be understood, however, that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates an embodiment of the invention having a telescoping tube and mechanical snare at its distal end. Multiple positions for several features are identified.

FIG. 2 illustrates an embodiment of the invention having a non-telescoping tube and mechanical snare at its distal end. Multiple positions for several features are identified.

FIG. 3 illustrates an embodiment of the invention having a telescoping tube, mechanical snare at its distal end, and a pistol grip. Multiple positions for several features are identified.

FIG. 4 illustrates one embodiment of the invention in a stored position. Multiple positions for several features are identified.

FIG. 5 illustrates a different embodiment of the invention having a pistol grip in a stored position. Multiple positions for several features are identified.

FIG. 6 illustrates another alternative embodiment of the invention having a telescoping tube, mechanical snare at its distal end, and a dual grip. Multiple positions for several features are identified.

### DETAILED DESCRIPTION

The invention provides a relatively lightweight, handheld device that combines a vacuum with a mechanical snare to pick up objects of various sizes and shapes without requiring the user to unduly bend, reach, or stoop to pick up the objects. Advantageously, the vacuum and mechanical snare can be operated together or separately as the user chooses. Thus, the invention provides improved versatility such that a user can operate a single device to accomplish multiple tasks without having to stop to add or remove an attachment or to use a second device.

Devices of the invention are useful for snaring (i.e. picking up) lightweight materials of various shapes and sizes and for collecting small objects such as pins, fasteners, buttons, paper, hearing aids, and lightweight objects of various sizes. Such materials and objects can be picked up and collected either together or separately.

Advantageously, the invention is designed so that it can be operated with one hand and extends a user's reach while allowing the user to use comparatively little strength or force to operate it.

Some embodiments of the invention can be compacted for storage, shipping, carrying, or easier transport.

The drawings illustrate various embodiments of the invention. Those of skill in the art will appreciate that not all aspects of the invention are illustrated. Rather, the drawings illustrate features of the invention that are likely to be considered important by a potential user. Thus, certain features, such as the internal motor, electrical cord, and the operating mechanism for the mechanical snare, are not illustrated.

Motors, solenoids, and electrical cords are well known in the art, and the skilled artisan will be familiar with a variety of suitable choices for inclusion in different embodiments of the invention.

Similarly, mechanisms such as pulleys, cables, rods and the like that can extend from the mechanical snare to the operating mechanism are well known and available for use in the invention. Those of skill in the art will appreciate that the exact choices will depend, at least in part, upon cost, weight, and ease of installation during manufacture and may vary between different embodiments of the invention.

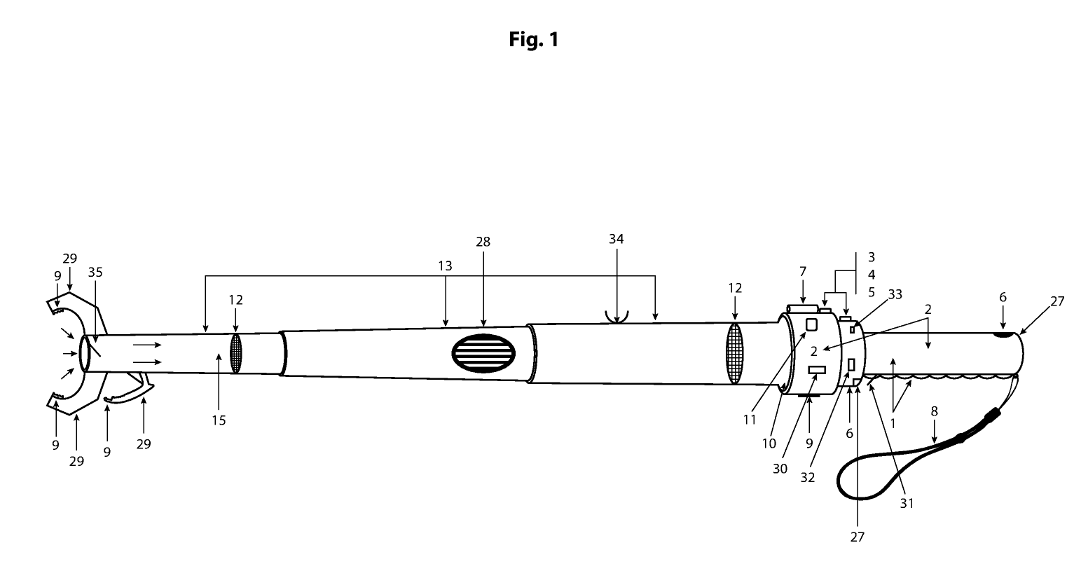

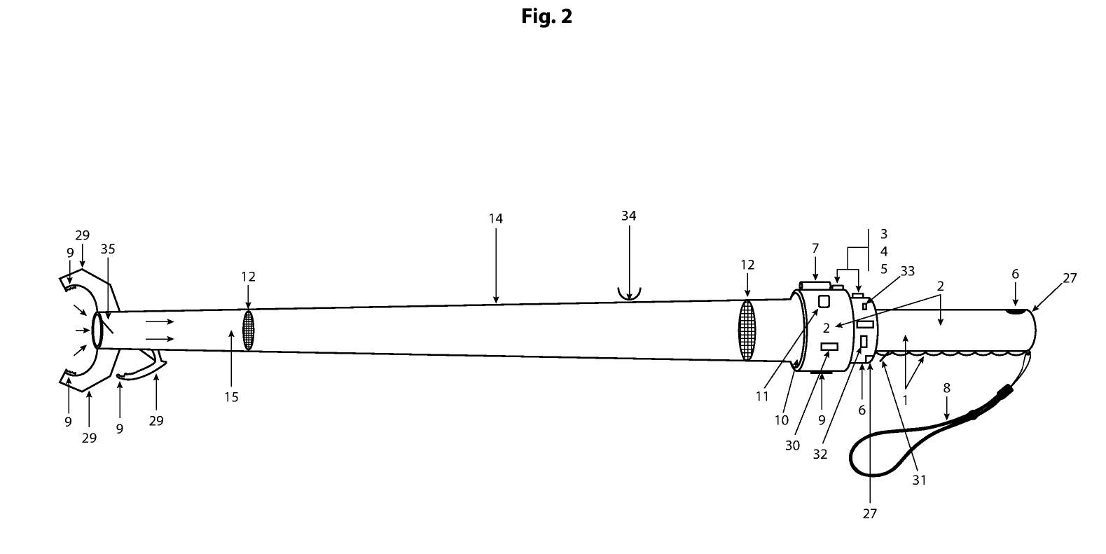

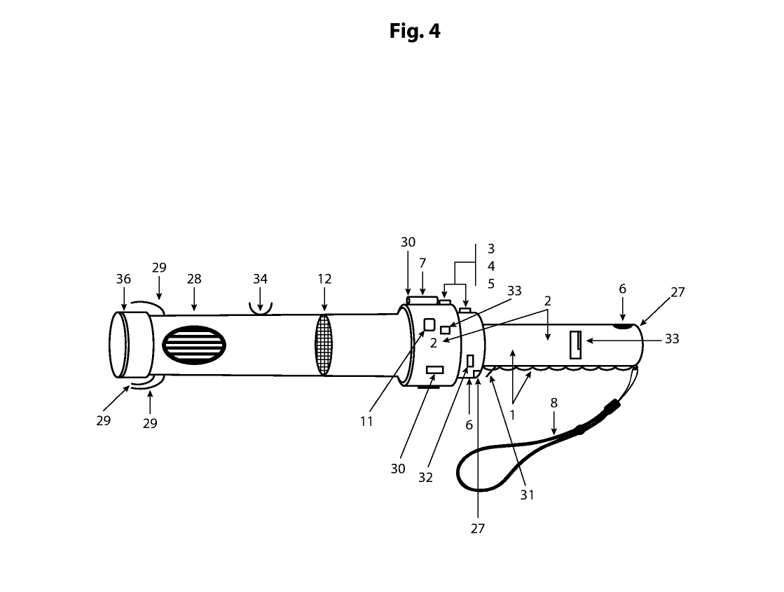

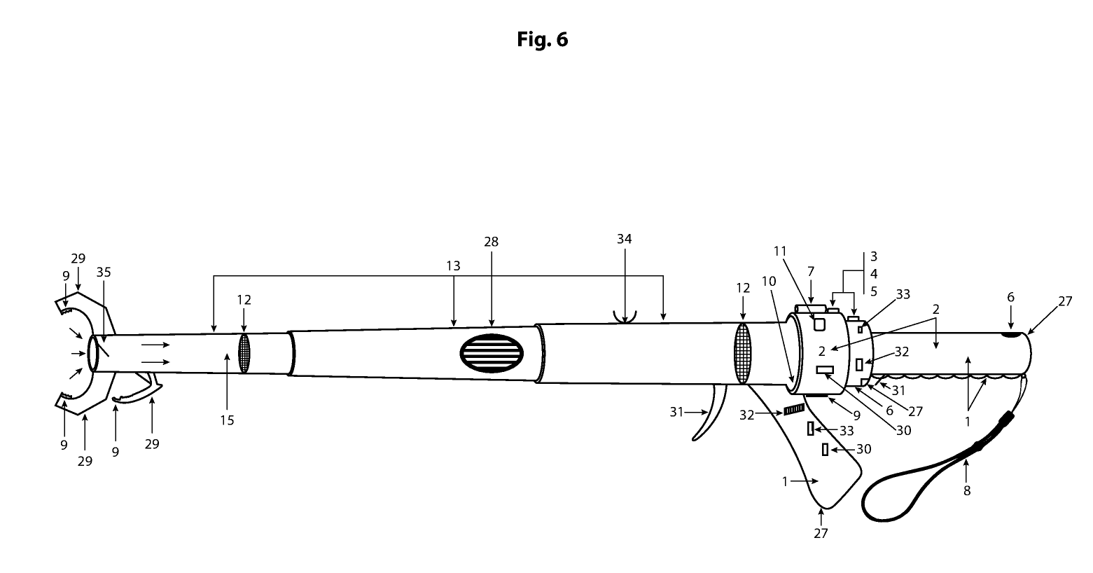

Various embodiments of the invention are illustrated in FIGS. 1-6. FIGS. 1 and 2 illustrate similar embodiments of the invention having a handle (1) with a straight grip. The embodiment in FIG. 2 shows a device having a tube (14) that is not retractable or collapsible. The embodiment shown in FIG. 1 includes a telescoping tube (13) that may be retracted or collapsed, as illustrated in FIG. 6. The advantage of a retractable or collapsible tube is that the device may be compacted for storage when not in use. Optionally, when not in use the open end of the tube (13 or 14, respectively) that is distal to the handle (1) can be covered with an end cap (36). For easier adjustment of the length of telescoping tube (13), a gripping pad or roughened surface (28) can be included in a device of the invention. Alternatively, the gripping pad or surface (28) may be an adjustable knob.

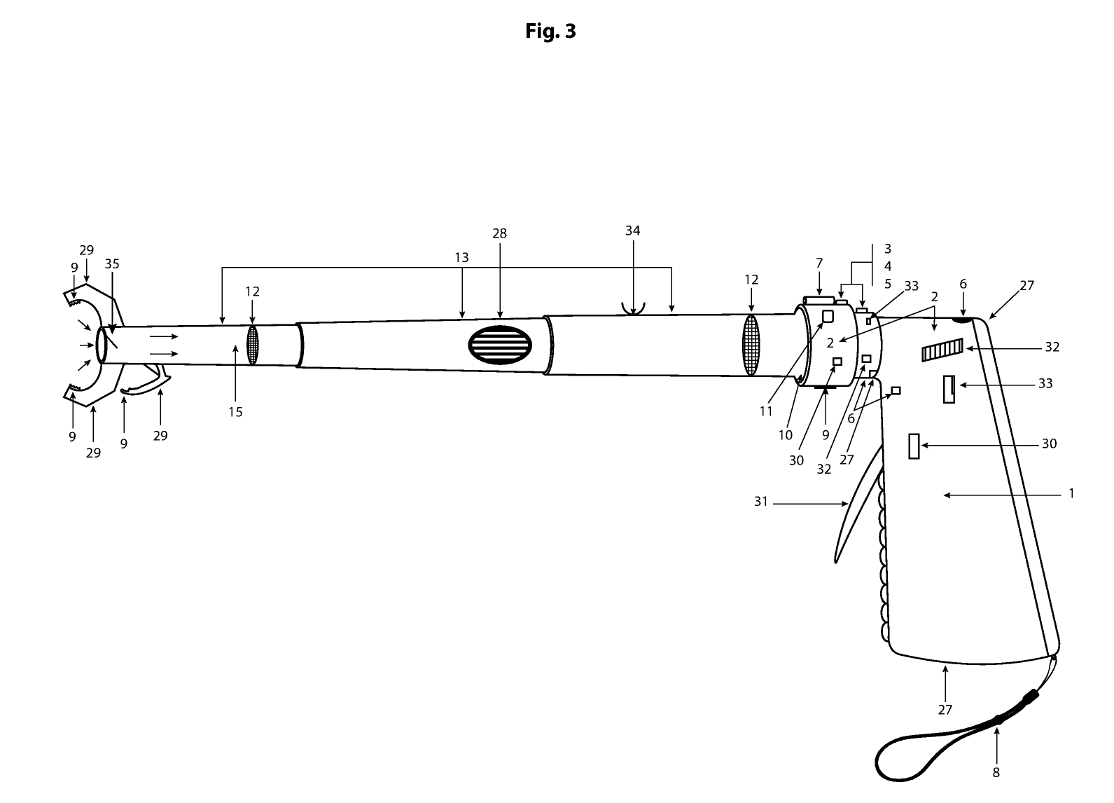

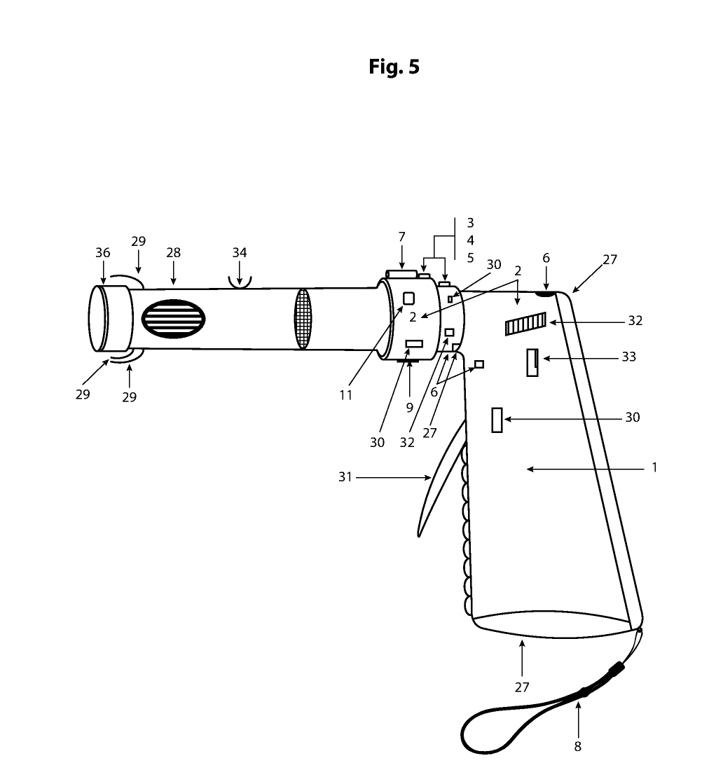

The embodiment of FIG. 3 is similar to that of FIG. 1, but includes a handle (1) with a pistol grip. Like the embodiment of FIG. 1, the embodiment of FIG. 3 has a tube (13) that can be retracted or collapsed as illustrated in FIG. 5.

The embodiment of FIG. 6 includes a handle (1) with a dual grip (i.e. both a straight grip and pistol grip), as well as, a telescoping tube (13) that may be retracted or collapsed. It will be understood that in the alternative the embodiment of FIG. 6 can include a tube (14) that does not retract or collapse.

During vacuum operation, air flows (as indicated by arrows in FIGS. 1-3, 6) from the distal opening of the tube (13 or 14, respectively) towards the handle (1) with enough force to create sufficient suction to pull material into the tube (13 or 14, respectively). Those of skill in the art will be familiar with the principles of vacuum technology and understand that the length of the tube, the size of the intake port, the force generated by the motor will, and rate of air flow will all effect the amount of suction that is created by the device.

To collect objects with the vacuum, the distal portion of the tube (13 or 14, respectively) is intended as a capture compartment (15). When vacuum pressure is applied, a closure flap (35) that covers the distal end of the tube (13 or 14, respectively) is pulled back so that air and objects can move into the tube (13 or 14, respectively). The closure flap (35) returns to its neutral position when the vacuum is no longer in operation and collected material is trapped inside the tube (13 or 14, respectively).

To prevent collected material from travelling the entire length of the tube (13 or 14, respectively) towards the handle (1), one or more filter guards (12) are present in the tube (13 or 14, respectively). Preferably at least one filter guard (12) is located, relative to the handle (1), in the distal half, third, or even the most distal quarter of the tube (13 or 14, respectively). And, preferably another filter guard (12) is located in the half, third, or even the quarter of the tube (13 or 14, respectively) most adjacent to the handle (1). When not in use, the distal end of the tube (13 or 14, respectively) may be covered by an end cap (36).

Also attached near the distal end and along the side of the tube (13 or 14, respectively) is a mechanical snare (29) that optionally includes teeth or magnets (37). As illustrated in FIGS. 1-3, and 6, the mechanical snare can have multiple claw-like appendages of varying sizes. While not shown, the mechanical snare (29) is connected to its on/off switch (30) and operational trigger (31) by a pulley, cable, or rod system—many of which are well-known in the art. The on/off switch (30) allows a user to select whether the mechanical snare is operational with the vacuum. The operational trigger (31) causes the mechanical snare (29) to close such that it can grab and hold an object. Separately, a release switch (32) opens the mechanical snare (29) to allow a held object to be released.

By having separate controls for opening and closing the mechanical snare, a user does not have to maintain constant pressure on a switch to keep the mechanical snare (29) closed and is less likely to inadvertently drop a collected object.

Optionally, an adjustable clip (34) may be included on the side of a tube (13 or 14, respectively) so that a device of the invention can be stored or attached to mobility equipment such as a walker or wheelchair.

So that a user can operate the vacuum with one hand, operating mechanisms for the vacuum are located near, in, or on the handle area. An exemplary arrangement of the operating mechanisms is shown in FIGS. 1-6. Those of skill in the art will understand that many different arrangements of the operating mechanisms can be made. Preferred arrangements are those that are easy for multiple different users to operate. For example, an on/off switch or button (3), light switch (4) to operate a light (7), and reverse switch or button (5) may be located on an upper, bottom, or side surface of the handle (1). The operating mechanisms may be adjacent to each other or separated onto different surfaces of the handle (1). Preferably, the light (7) is an LED light that operates in the visible light range so that a user can collect material in dim light or in the dark.

Optionally, a wrist strap (8) may be attached to the handle (1) for easier carrying. Either in addition to or in place of a wrist strap, a magnet, clip, or hook (9) may be on a side of the handle (1) so that a device can be easily stored or carried (e.g. on a wheelchair, walker, or in a closet). Optionally, one or more reflectors may be present on the side(s) of the handle (1) or tube (13 or 14, respectively) so that the vacuum may be operated with greater safety at night. One or more reflectors may be placed on the distal portion of the tube (13 or 14, respectively) so that a user may more easily identify the distal opening to the tube (13 or 14, respectively).

The vacuum operates by using an electric motor, preferably having a power cord that retracts through an opening (27) into the handle (1). While the motor may be located within the device in multiple positions, such as either along a side of the tube (11), or at or near the bottom or top of the device, it is preferred that the motor is located within the handle (1) so that the device's weight is better balanced for the user. While the motor is not shown in the accompanying figures, the preferred region (2) of the handle (1) within which the motor is placed is identified. Preferably, the motor is operated with an electrical cord that is located in the preferred region (2) of the handle (1) or adjacent to it.

Alternatively, if the motor is battery-operated, then preferably the battery(ies) is located in or adjacent to the handle (1), most preferably the battery(ies) is located in the preferred region (2) of the handle (1). Preferably, one or more vents (6) are located near the motor. The motor may include a fan (not shown).

Unless defined otherwise, all technical and scientific terms used herein have the same meaning as is commonly understood by one of skill in the art to which this invention belongs at the time of filing. The meaning and scope of terms should be clear; however, in the event of any latent ambiguity, definitions provided herein take precedent over any dictionary or extrinsic definition. It is to be understood that the terminology used is for the purpose of describing particular embodiments of the invention and is not intended to be limiting. Further, unless otherwise required by context, singular terms shall include pluralities and plural terms shall include the singular. Herein, the use of “or” means “and/or” unless stated otherwise. Furthermore, the use of the term “including”, as well as other forms such as “includes” and “included” is not limiting. Similarly, the use of the terms “comprising” and “having” and their other forms are not limiting.

Those of skill in the art should, in light of the present disclosure, appreciate that many changes can be made in the specific embodiments which are disclosed and still obtain a like or similar result without departing from the spirit and scope of the invention. Thus it should be understood that the terminology used herein is for the purpose of describing exemplary embodiments of the invention and is not intended to be limiting to only those embodiments to the exclusion of equivalent embodiments with which the skilled artisan would be familiar. All of the devices and methods disclosed and claimed herein can be made and executed without undue experimentation in light of the present disclosure.

What is claimed is:

1. A device comprising
a) a handle;
b) a motor that can generate vacuum pressure and is housed within the handle, ;
c) a tube attached to the handle and through which the vacuum pressure can pass, wherein the tube includes a closure flap, a capture compartment and a filter guard in the half of the tube distal from the handle; and
d) a mechanical snare comprising two or more movable appendages attached to the side of the tube near the end of the tube distal to the handle, wherein during operation the appendages are movable and able to hold and release an object,
wherein the device is handheld.

2. The device of claim 1, wherein the motor includes an electric cord or battery.

3. The device of claim 1, wherein a second filter guard is located in the half of the tube adjacent to the handle.

4. The device of claim 1, wherein the tube is a telescoping tube.

5. The device of claim 1, wherein the handle further includes an operating mechanism for the vacuum.

6. The device of claim 1, wherein the handle further includes an operating mechanism for the mechanical snare. The device of claim 1, wherein the handle further includes a wrist strap, reflector, light, or any combination thereof.

8. The device of claim 1, wherein the tube further includes a reflector, light, or any combination thereof.

9. A method of collecting objects comprising operating a handheld device having a handle; a motor that can generate vacuum pressure and is housed within the handle; a tube attached to the handle and through which the vacuum pressure can pass, wherein the tube includes a closure flap, a capture compartment and a filter guard in the half of the tube distal from the handle; and a mechanical snare comprising two or more movable appendages attached to the side of the tube near the end of the tube distal to the handle, wherein during operation a vacuum is generated such that an object is drawn into the capture compartment and the appendages are movable and able to hold and release an object.
